(19) United States
(12) Patent Application Publication
(10) Pub. No.: US 2021/0232335 A1
(43) Pub. Date: Jul. 29, 2021

(54) INSPECTION SYSTEM, INSPECTION METHOD, AND COMPUTER-READABLE RECORDING MEDIUM RECORDING INSPECTION PROGRAM

(71) Applicant: FUJITSU LIMITED, Kawasaki-shi (JP)

(72) Inventor: Seiji Terunuma, Fuji (JP)

(73) Assignee: FUJITSU LIMITED, Kawasaki-shi (JP)

(21) Appl. No.: 17/133,944

(22) Filed: Dec. 24, 2020

(30) Foreign Application Priority Data
Jan. 24, 2020 (JP) 2020-009887

(51) Int. Cl. G06F 3/06

(52) U.S. Cl. CPC G06F 3/0653; G06F 3/0673; G06F 3/062

(57) ABSTRACT

An inspection system includes: a memory; and a processor coupled to the memory and configured to: generate, upon compilation, first information related to allocation of an area of access target data and correlate the first information with an inspection target program based on whether or not access to the access target data when the inspection target program is executed is access to inspection target data with a possibility of violation access to an area other than a memory area of the data; and perform allocation to prohibit the violation access for the inspection target data based on the first information generated by the generation unit in the allocation of the area of the access target data when execution of the inspection target program is started.

### CROSS-REFERENCE TO RELATED APPLICATION

This application is based upon and claims the benefit of priority of the prior Japanese Patent Application No. 2020-9887, filed on Jan. 24, 2020, the entire contents of which are incorporated herein by reference.

### FIELD

The embodiments discussed herein are related to an inspection system, an inspection method, and a computer-readable recording medium.

### BACKGROUND

When a program is executed, an area of data B allocated adjacent to data A may be destroyed due to writing beyond an area range of the data A. Such area destruction is called memory area overrun.

Examples of the existing techniques include Japanese Laid-open Patent Publication No. 2006-185233 and Japanese Laid-open Patent Publication No. 2010-198147.

### SUMMARY

According to an aspect of the embodiments, an inspection system includes: a memory; and a processor coupled to the memory and configured to: generate, upon compilation, first information related to allocation of an area of access target data and correlate the first information with an inspection target program based on whether or not access to the access target data when the inspection target program is executed is access to inspection target data with a possibility of violation access to an area other than a memory area of the data; and perform allocation to prohibit the violation access for the inspection target data based on the first information generated by the generation unit in the allocation of the area of the access target data when execution of the inspection target program is started.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B are diagrams illustrating an example of a program that is inspected by an inspection apparatus according to the embodiment;

FIGS. 2A and 2B are diagrams illustrating data area allocation of the program illustrated in FIGS. 1A and 1B;

FIG. 3 is a diagram illustrating a functional configuration of the inspection apparatus according to the embodiment;

FIG. 4 is a diagram illustrating a functional configuration of a compilation unit;

FIG. 5 is a diagram illustrating an example of area allocation information;

FIG. 6 is a diagram illustrating an example of an instruction group to access pieces of data using pointers;

FIG. 7 is a diagram illustrating a functional configuration of an execution unit;

FIGS. 8A and 8B are a flowchart illustrating a flow of area allocation processing;

FIG. 9 is a flowchart illustrating a flow of processing of outputting the area allocation information;

FIG. 10 is a flowchart illustrating a flow of processing of developing area acquisition processing to a code portion to be executed when an inspection target program becomes valid from invalid;

FIG. 11 is a flowchart illustrating a flow of processing of developing area release processing to a code portion to be executed when the inspection target program becomes invalid from valid;

FIG. 12 is a flowchart illustrating a flow of processing of analyzing a memory area overrun inspection option by an option analysis unit;

FIG. 13 is a flowchart illustrating a flow of processing by a data area acquisition unit;

FIG. 14A is a first flowchart illustrating a flow of the area allocation processing when inspection is valid;

FIG. 14B is a second flowchart illustrating a flow of the area allocation processing when the inspection is valid;

FIG. 15 is a flowchart illustrating a flow of the area allocation processing when the inspection is invalid;

FIG. 16 is a flowchart illustrating a flow of processing by a data area release unit;

FIG. 17 is a flowchart illustrating a flow of the area release processing when the inspection is valid;

FIG. 18 is a flowchart illustrating a flow of the area release processing when the inspection is invalid;

FIG. 19 is a diagram for explaining effects by the inspection apparatus; and

FIG. 20 is a diagram illustrating a hardware configuration of a computer that executes an inspection program according to the embodiment.

### DESCRIPTION OF EMBODIMENTS

When the memory area overrun occurs, no abnormality occurs at the time of the occurrence of the overrun. Destruction of the data B is detected only when processing is performed by using a value of the destroyed data B and abnormal termination or the like occurs. For this reason, when the abnormal termination or the like does not occur, the area destruction of the data B may not be detected. In order not to cause occurrence of a failure due to such undetected area destruction, there is a technique for detecting area destruction.

For example, as a technique for detecting writing beyond an area of an array, there is an existing technique in which writing beyond an area of an array is detected as writing into a non-writeable area by arranging the array in an adjacent area before the non-writeable area.

There is a technique in which a copy of data to be stored in a stack area is stored at the same time, the stored data and the copy data are compared with each other when a program is executed, execution of the program is stopped when the stored data and the copy data are different from each other, and a user is notified of abnormality of the data stored in the stack area.

In the existing technique in which writing beyond the area of the array is detected as writing into the non-writeable area by arranging the array in the adjacent area before the non-writeable area, a fixed detection mechanism is embedded upon translation. For this reason, this existing technique has the problem that flexible operation of the detection mechanism by controlling validity and invalidity of the detection mechanism at runtime is impossible.

Although NetCOBOL has a function of detecting memory area overrun by specifying a translation option, it is impossible to detect the memory area overrun when a program created in a language other than NetCOBOL is called. There is a tool for detecting the memory area overrun as a debugging tool, it is not possible to detect the memory area overrun occurring in a module to which the tool is not applied.

An object of one aspect of the embodiment is to enable validity and invalidity of a detection mechanism of memory area overrun to be controlled at runtime. Hereinafter, embodiments of an inspection system, an inspection method, and an inspection program disclosed in the present application will be described in detail with reference to the drawings. Note that the embodiments do not limit the disclosed technology.

### Embodiment

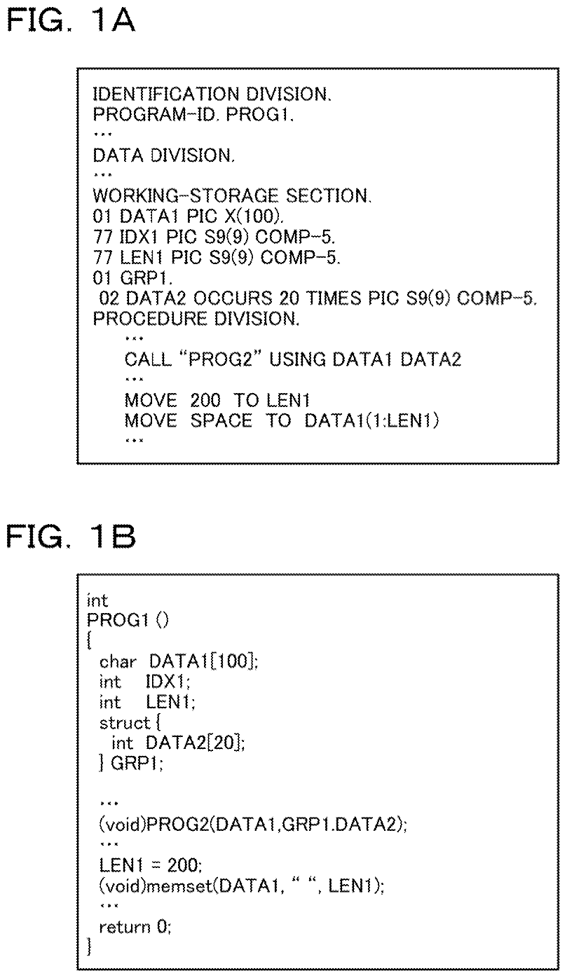

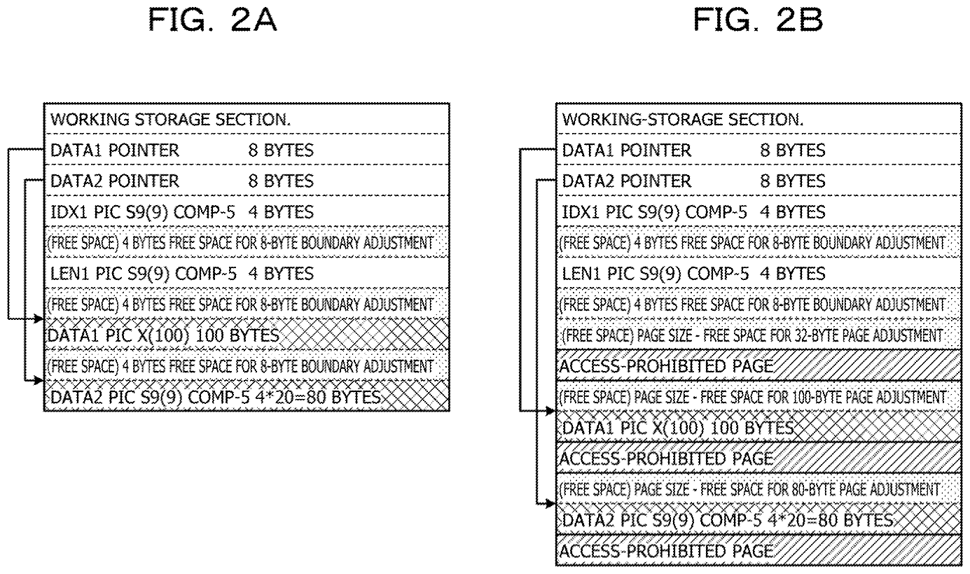

First, data area allocation by the inspection apparatus according to the embodiment will be described with reference to FIGS. 1A, 1B, 2A, and 2B. FIGS. 1A and 1B are diagrams illustrating an example of an inspection target program that is inspected by the inspection apparatus according to the embodiment. FIG. 1A illustrates an example of a COBOL program, and FIG. 1B illustrates an example of a C program.

In these programs, “DATA1”, “IDX1”, “LEN1”, and “GRP1” are used as pieces of data. “DATA1” is an array with a size of 100, and the size of an element is one byte. Each of “IDX1” and “LEN1” is four-byte data. “GRP1” is a structure having “DATA2” as a member. “DATA2” is an array having a size of 20, and the size of an element is four bytes.

In FIGS. 1A and 1B, “DATA1” is designated as an argument of address passing when “PROG2” is called, and writing into “DATA1 [200]” is performed, resulting in occurrence of memory area overrun.

FIGS. 2A and 2B are diagrams illustrating data area allocation of the program illustrated in FIGS. 1A and 1B. FIG. 2A illustrates the allocation when inspection is invalid, and FIG. 2B illustrates the allocation when the inspection is valid. The inspection invalidity indicates that memory area overrun inspection is invalid, and the inspection validity indicates that the memory area overrun inspection is valid. “WORKING-STORAGE-SECTION” indicates area allocation of data. The arrays are accessed using pointers. The area to which data is allocated is ensured by a runtime library at runtime.

As illustrated in FIG. 2A, when the inspection is invalid, the inspection apparatus according to the embodiment allocates eight bytes as each of “DATA1 pointer” and “DATA2 pointer”. The inspection apparatus according to the embodiment allocates four bytes as “IDX”, four bytes as a free space for eight-byte boundary adjustment, four bytes as “LEN1”, and four bytes as a free space for eight-byte boundary adjustment. The inspection apparatus according to the embodiment allocates 100 bytes as “DATA1”, four bytes as a free space for eight-byte boundary adjustment, and 80 bytes as “DATA2”.

On the other hand, when the inspection is valid, the inspection apparatus according to the embodiment allocates eight bytes as each of “DATA1 pointer” and “DATA2 pointer”, as illustrated in FIG. 2B. The inspection apparatus according to the embodiment allocates four bytes as “IDX1”, four bytes as a free space for eight-byte boundary adjustment, four bytes as “LEN1”, and four bytes as a free space for eight-byte boundary adjustment. The inspection apparatus according to the embodiment provides a free space of page size—32 bytes as a free space for page adjustment and prohibits access to a next page.

The inspection apparatus according to the embodiment provides a free space of page size—100 bytes as a free space for page adjustment, allocates 100 bytes as “DATA1”, and prohibits access to a next page. By providing the free space of page size—100 bytes as the free space for page adjustment, the inspection apparatus according to the embodiment may place “DATA1” before the access-prohibited page in an adjacent manner.

The inspection apparatus according to the embodiment provides a free space of page size—80 bytes as a free space for page adjustment, allocates 80 bytes as “DATA2”, and prohibits access to a next page. By providing the free space of page size—80 bytes as the free space for page adjustment, the inspection apparatus according to the embodiment may place “DATA2” before the access-prohibited page in an adjacent manner.

As described above, the inspection apparatus according to the embodiment places each of “DATA1” and “DATA2”, which may cause the memory area overrun, before the access-prohibited page in the adjacent manner. The inspection apparatus according to the embodiment therefore enables an operating system (OS) to detect access violation when the memory area overrun occurs. In FIG. 2B, there may be no access-prohibited page between “LEN1” and “DATA1”.

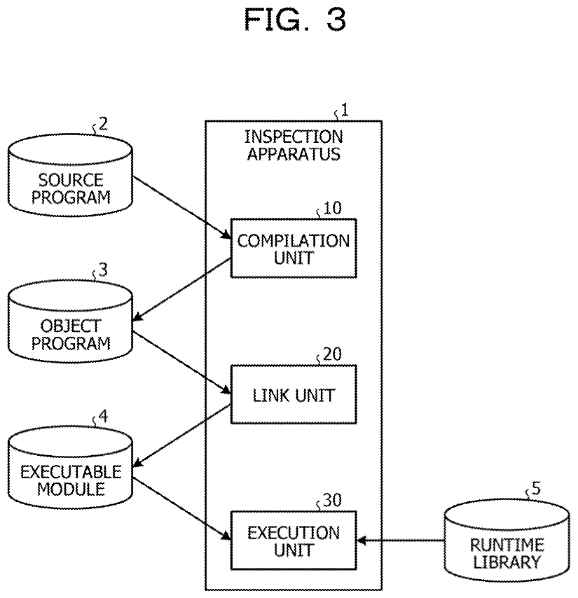

Next, a functional configuration of the inspection apparatus according to the embodiment will be described. FIG. 3 is a diagram illustrating the functional configuration of the inspection apparatus according to the embodiment. As illustrated in FIG. 3, an inspection apparatus 1 according to the embodiment includes a compilation unit 10, a link unit 20, and an execution unit 30 as functions. The compilation unit in FIG. 3 is an example of a generation unit, and the execution unit 30 in FIG. 3 is an example of an allocator.

The compilation unit 10 reads a source program 2 and generates an object program 3. The compilation unit 10, for example, reads the source program 2 from a file and writes the object program 3 into a file. When validity of the memory area overrun inspection is designated by a compile option, the compilation unit 10 generates area allocation information, which is information for allocation illustrated in FIG. 2B, and embeds the area allocation information in the object program 3. The area allocation information will be described in detail later.

A user designates execution of the compilation, the source file, the object file, and the compile option by using, for example, a keyboard or a mouse. The compilation unit 10 is implemented by executing a compiler program by a computer.

The link unit 20 reads the object program 3 and generates an executable module 4. The link unit 20 writes the executable module 4 into a file, for example. The link unit 20 is implemented by executing a linker program by the computer.

The execution unit 30 executes the executable module 4 generated by the link unit 20 together with a runtime library 5. When validity of the memory area overrun inspection is designated by a runtime option, the runtime library 5 performs area allocation when the inspection is valid based on the area allocation information.

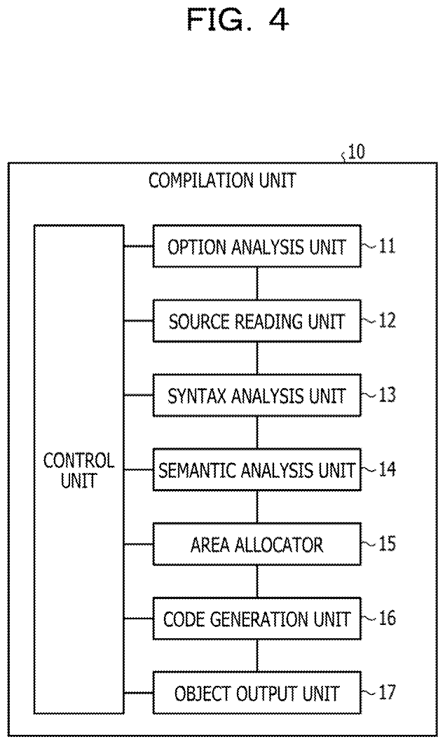

FIG. 4 is a diagram illustrating a functional configuration of the compilation unit 10. As illustrated in FIG. 4, the compilation unit 10 includes an option analysis unit 11, a source reading unit 12, a syntax analysis unit 13, a semantic analysis unit 14, an area allocator 15, a code generation unit 16, and an object output unit 17.

The option analysis unit 11 analyzes the compile option. For example, the option analysis unit 11 specifies whether or not the memory area overrun inspection is valid. The source reading unit 12 reads the source program 2.

The syntax analysis unit 13 performs syntax analysis of the source program 2. The semantic analysis unit 14 performs semantic analysis of the source program 2 based on the syntax analysis result. When the memory area overrun inspection is valid, the compilation unit 10 specifies data that may destroy subsequent data as inspection target data and adds a mark to the specified inspection target data in the syntax analysis and the semantic analysis.

Examples of the inspection target data include the following. An array, a structure including an array, data passed by address (BY REFERENCE) by a call (CALL statement), data having an external attribute (EXTERNAL), data accessed using a pointer, a character string partially referenced, and a structure including a character string partially referenced.

When the memory area overrun inspection is valid, the area allocator 15 performs allocation for the inspection target data to which the mark has been added such that allocation of the area is changeable at runtime, and generates the area allocation information. The area allocation information includes information for the runtime library 5 to set a pointer to the data at runtime and information about the size of the inspection target data.

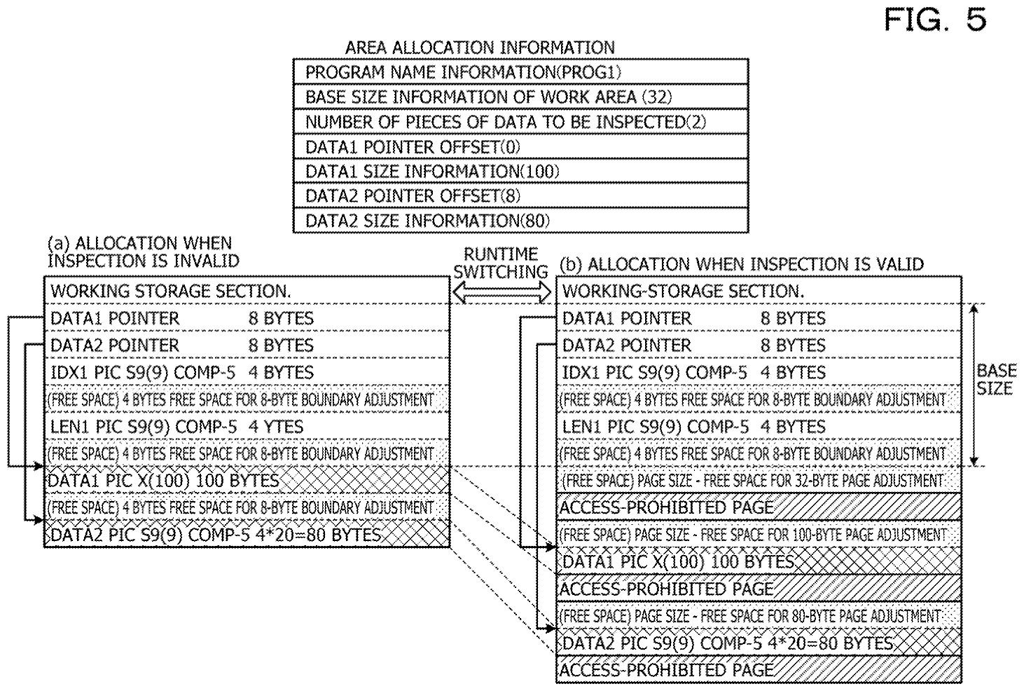

FIG. 5 is a diagram illustrating an example of the area allocation information. As illustrated in FIG. 5, the area allocation information includes program name information, base size information of a work area, the number of pieces of data to be inspected, DATA1 pointer offset, DATA size information, DATA2 pointer offset, and DATA2 size information.

The program name information is the name of a program and is “PROG1” in this example. The base size information of the work area is a byte size from “DATA1 pointer” to the free space for eight-byte boundary adjustment subsequent to “LEN1” and is “32” in this example. The number of pieces of data to be inspected is the number of pieces of inspection target data and is “2” in this example.

The DATA1 pointer offset is an offset of “DATA1 pointer” from the head of a data area and is “0” in this example. The DATA size information is the size of “DATA1” and is “100” in this example. The DATA2 pointer offset is an offset of “DATA2 pointer” from the head of the data area and is “8” in this example. The DATA2 size information is the size of “DATA2” and is “80” in this example.

Returning to FIG. 4, the code generation unit 16 generates an object code based on the syntax analysis result and the semantic analysis result. In the generation of the object code, the code generation unit 16 sets an instruction to access the inspection target data such that a pointer to the inspection target data is loaded and the inspection target data is accessed using the loaded pointer.

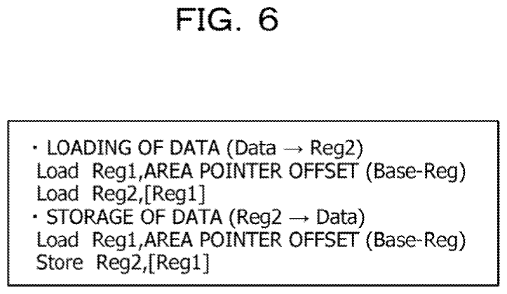

FIG. 6 is a diagram illustrating an example of an instruction group to access pieces of data using pointers. In FIG. 6, Base-Reg holds a base address of an area. As illustrated in FIG. 6, when “Data” is loaded into “Reg2”, the base address of the area is added to an area pointer offset of “Data”, the resultant is loaded into “Reg1”, and data of an address designated by “Reg1” is loaded into “Reg2”.

Similarly, when a value of “Reg2” is stored in “Data”, the base address of the area is added to the area pointer offset of “Data”, the resultant is loaded into “Reg1”, and the value of “Reg2” is stored in the address designated by “Reg1”.

The code generation unit 16 embeds the area allocation information in the object code. When the object code is composed of a plurality of sections, the code generation unit 16 embeds the area allocation information in a read-only section such as .text and .rodata, for example. The code generation unit 16 may output the area allocation information to a predetermined file, for example, instead of embedding of the area allocation information in the object code. For example, the area allocation information may be output to a place other than the object code as long as the area allocation information is associated with the object code of the inspection target program.

The code generation unit 16 embeds a code for calling the runtime library 5 that acquires an area based on the area allocation information in a code portion to be executed when execution of the inspection target program is started. The code generation unit 16 embeds a code for calling the runtime library 5 that releases an area based on the area allocation information in a code portion to be executed when execution of the inspection target program is ended.

The object output unit 17 outputs the object code generated by the code generation unit 16 to, for example, a file.

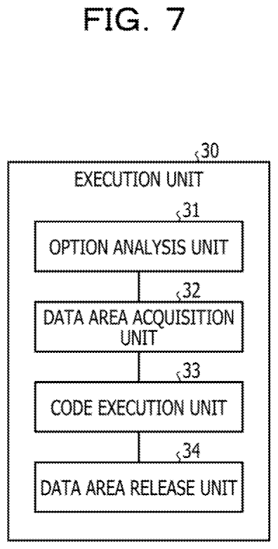

FIG. 7 is a diagram illustrating the functional configuration of the execution unit 30. As illustrated in FIG. 7, the execution unit 30 includes an option analysis unit 31, a data area acquisition unit 32, a code execution unit 33, and a data area release unit 34.

The option analysis unit 31 analyzes the runtime option. For example, the option analysis unit 31 specifies whether or not the memory area overrun inspection is valid.

The data area acquisition unit 32 acquires a data area based on the area allocation information and performs area allocation. The data area acquisition unit 32 sets the address of the allocated data to a pointer for accessing the data. As illustrated in FIG. 6, the instruction to access the inspection target data is configured such that the data is accessed via the pointer. The executable module 4 therefore accesses the data via the pointer set by the data area acquisition unit 32 at runtime. The processing of the data area acquisition unit 32 is performed by the runtime library 5.

The code execution unit 33 executes the executable module 4 by transferring control to the executable module 4.

When execution of the executable module 4 is completed, the data area release unit 34 releases the data area acquired by the data area acquisition unit 32.

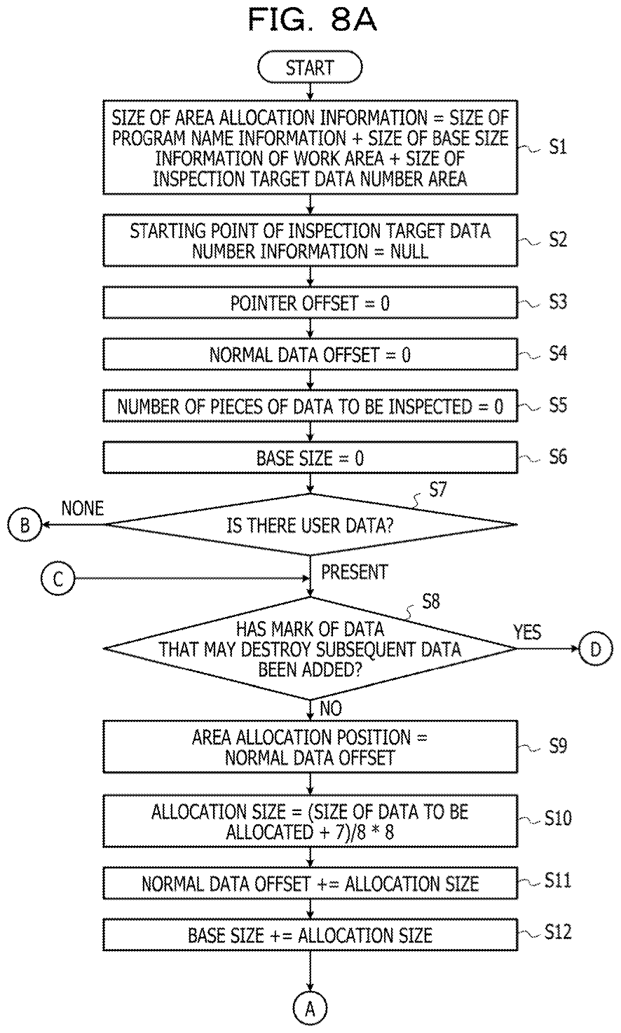

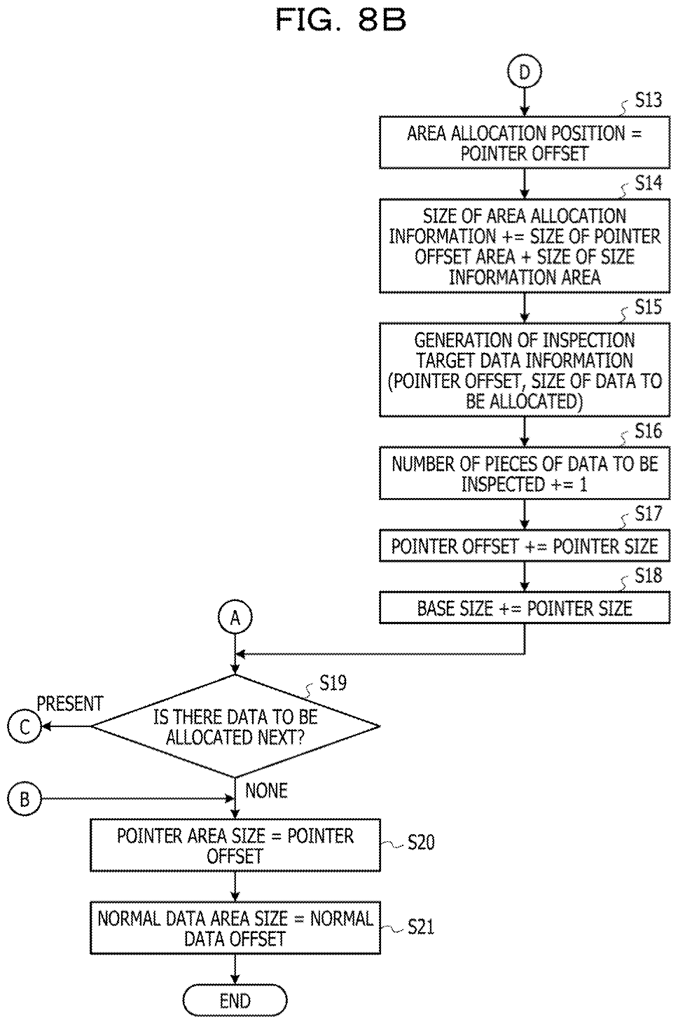

Next, a flow of processing by the compilation unit 10 will be described with reference to FIGS. 8 to 11. FIGS. 8A and 8B are a flowchart illustrating a flow of the area allocation processing. As illustrated in FIGS. 8A and 88, the area allocator 15 initializes the size of the area allocation information by adding the size of the program name information, the size of the base size information of the work area, and the size of inspection target data number area (step S1). The area allocator 15 initializes a starting point of inspection target data information to NULL (step S2), initializes a pointer offset to 0 (step S3), and initializes a normal data offset to 0 (step S4). The area allocator 15 initializes the number of pieces of data to be inspected to 0 (step S5) and initializes a base size to 0 (step S6).

The area allocator 15 determines whether or not there is user data (step S7). When there is no user data, the process proceeds to step S20. On the other hand, when there is the user data, the area allocator 15 determines whether or not the mark indicating data that may destroy subsequent data has been added thereto (step S8).

When no mark has been added, the area allocator 15 sets the normal data offset at an area allocation position (step S9) and sets, as an allocation size, a value obtained by multiplying, by 8, a quotient obtained by adding 7 to the size of the data to be allocated and dividing the resultant by 8 (step S10). In this example, the boundary size is 8. The area allocator 15 adds the allocation size to the normal data offset (step S11) and adds the allocation size to the base size (step S12).

The area allocator 15 determines whether or not there is data to be allocated next (step S19). When there is the data, the process returns to step S8. On the other hand, when there is no data to be allocated next, the area allocator 15 sets the pointer offset to a pointer area size (step S20) and sets the normal data offset to a normal data area size (step S21).

When the mark indicating the data that may destroy the subsequent data has been added at step S8, the area allocator 15 sets the pointer offset at the area allocation position (step S13). The area allocator 15 adds the size of a pointer offset area and the size of a size information area to the size of the area allocation information (step S14) and generates inspection target data information (step S15). The inspection target data information is the size of the pointer offset and the data to be allocated. The area allocator 15 adds 1 to the number of pieces of data to be inspected (step S16), adds the pointer size to the pointer offset (step S17), and adds the pointer size to the base size (step S18). The area allocator 15 moves to step S19.

As described above, the area allocator 15 generates the pieces of information for generating the area allocation information while performing the allocation. The code generation unit 16 may therefore generate the area allocation information. The size of the area allocation information, the pointer area size, the normal data area size, and the like are used when the object is generated.

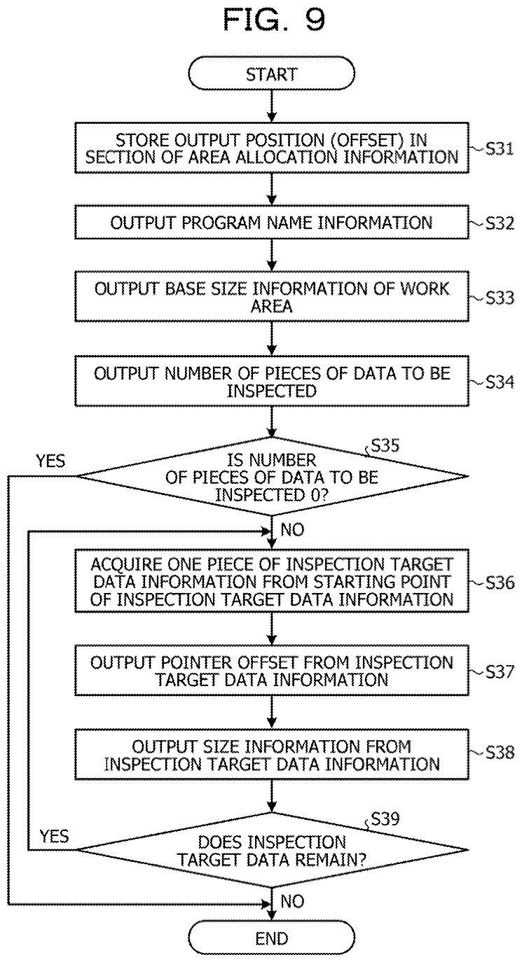

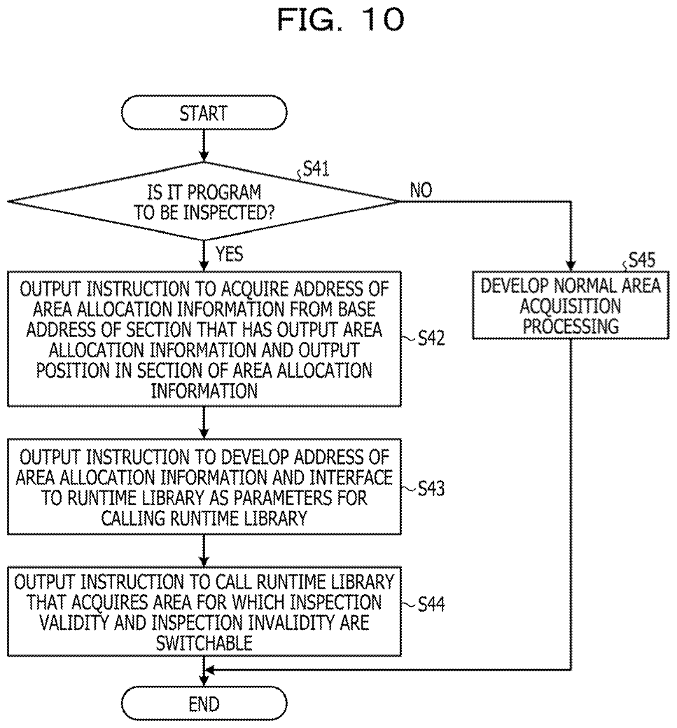

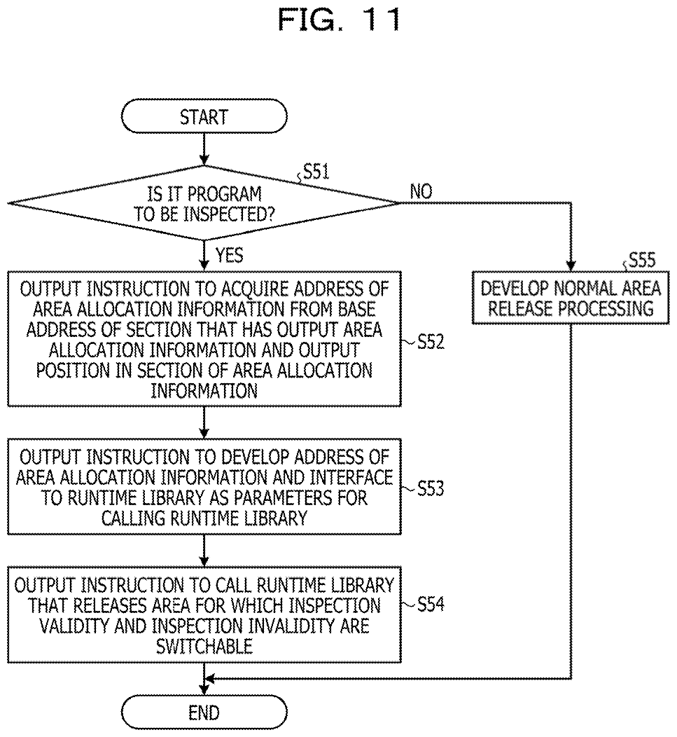

FIG. 9 is a flowchart illustrating a flow of processing of outputting the area allocation information. As illustrated in FIG. 9, the code generation unit 16 stores an output position (offset) in the section of the area allocation information (step S31). The code generation unit 16 uses the stored output position in the pieces of processing illustrated in FIGS. 10 and 11.

The code generation unit 16 outputs the program name information (step S32) and outputs the base size information of the work area (step S33). The code generation unit 16 outputs the base size as the base size information of the work area. The code generation unit 16 outputs the number of pieces of data to be inspected (step S34). The code generation unit 16 determines whether or not the number of pieces of data to be inspected is 0 (step S35). When the number of pieces of data to be inspected is 0, the process ends.

On the other hand, when the number of pieces of data to be inspected is not 0, the code generation unit 16 acquires one piece of inspection target data information from the starting point of the inspection target data information (step S36). The code generation unit 16 outputs the pointer offset from the inspection target data information (step S37) and outputs the size information from the inspection target data information (step S38). The code generation unit 16 determines whether or not the inspection target data remains (step S39). When the inspection target data remains, the process returns to step S36, and when the inspection target data does not remain, the process ends.

The code generation unit 16 outputs the area allocation information as described above. The execution unit 30 may, therefore, perform area acquisition and data allocation based on the area allocation information.

FIG. 10 is a flowchart illustrating a flow of processing of developing area acquisition processing to a code portion to be executed when the inspection target program becomes valid from invalid. As illustrated in FIG. 10, the code generation unit 16 determines whether or not the program is the inspection target program (step S41). When the program is not the inspection target program, the code generation unit 16 develops normal area acquisition processing (step S45).

On the other hand, when the program is the inspection target program, the code generation unit 16 outputs an instruction to acquire the address of the area allocation information from the base address of the section that has output the area allocation information and the output position in the section of the area allocation information (step S42). The code generation unit 16 outputs an instruction to develop the address of the area allocation information and an interface to the runtime library 5 as parameters for calling the runtime library 5 (step S43). The code generation unit 16 outputs an instruction to call the runtime library 5 that acquires an area for which the inspection validity and the inspection invalidity are switchable (step S44).

As described above, the code generation unit 16 outputs the instruction to acquire the address of the area allocation information, the instruction to develop the parameters for calling the runtime library 5, and the instruction to call the runtime library 5 that acquires the area for which the inspection validity and the inspection invalidity are switchable. When execution of the inspection target program is started, the execution unit 30 may acquire the area for which the inspection validity and the inspection invalidity are switchable.

FIG. 11 is a flowchart illustrating a flow of processing of developing area release processing to a code portion to be executed when the inspection target program becomes invalid from valid. As illustrated in FIG. 11, the code generation unit 16 determines whether or not the program is the inspection target program (step S51). When the program is not the inspection target program, the code generation unit 16 develops normal area release processing (step S55).

On the other hand, when the program is the inspection target program, the code generation unit 16 outputs an instruction to acquire the address of the area allocation information from the base address of the section that has output the area allocation information and the output position in the section of the area allocation information (step S52). The code generation unit 16 outputs an instruction to develop the address of the area allocation information and the interface to the runtime library 5 as parameters for calling the runtime library 5 (step S53). The code generation unit 16 outputs an instruction to call the runtime library 5 that releases the area for which the inspection validity and the inspection invalidity are switchable (step S54).

As described above, the code generation unit 16 outputs the instruction to acquire the address of the area allocation information, the instruction to develop the parameters for calling the runtime library 5, and the instruction to call the runtime library 5 that releases the area for which the inspection validity and the inspection invalidity are switchable. When execution of the inspection target program is ended, the execution unit 30 may release the area for which the inspection validity and the inspection invalidity are switchable.

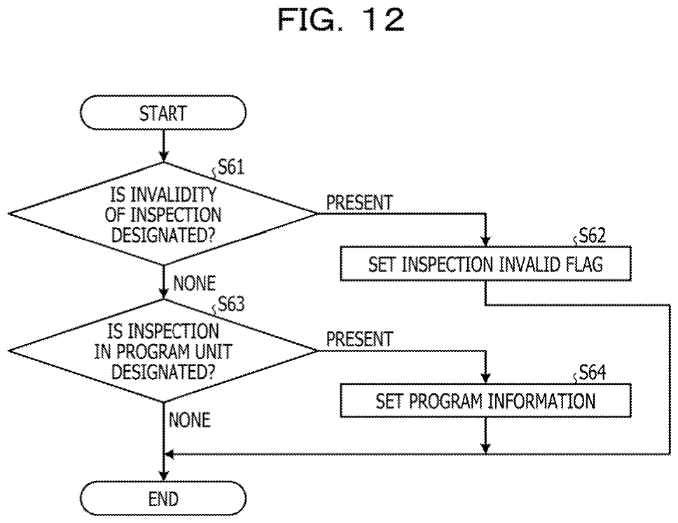

Next, a flow of processing by the execution unit 30 will be described with reference to FIGS. 12 to 18. FIG. 12 is a flowchart illustrating a flow of processing in which the option analysis unit 31 analyzes a memory area overrun inspection option. As illustrated in FIG. 12, the option analysis unit 31 determines whether or not invalidity of the memory area overrun inspection is designated (step S61). When the invalidity of the memory area overrun inspection is designated, the option analysis unit 31 sets an inspection invalid flag (step S62).

On the other hand, when the invalidity of the memory area overrun inspection is not designated, the option analysis unit 31 determines whether or not inspection in a program unit is designated (step S63). When the inspection in the program unit is designated, the option analysis unit 31 sets program information (step S64).

The option analysis unit 31 analyzes the memory area overrun inspection option as described above. The data area acquisition unit 32 may, therefore, acquire and allocate the data area based on the memory area overrun inspection option.

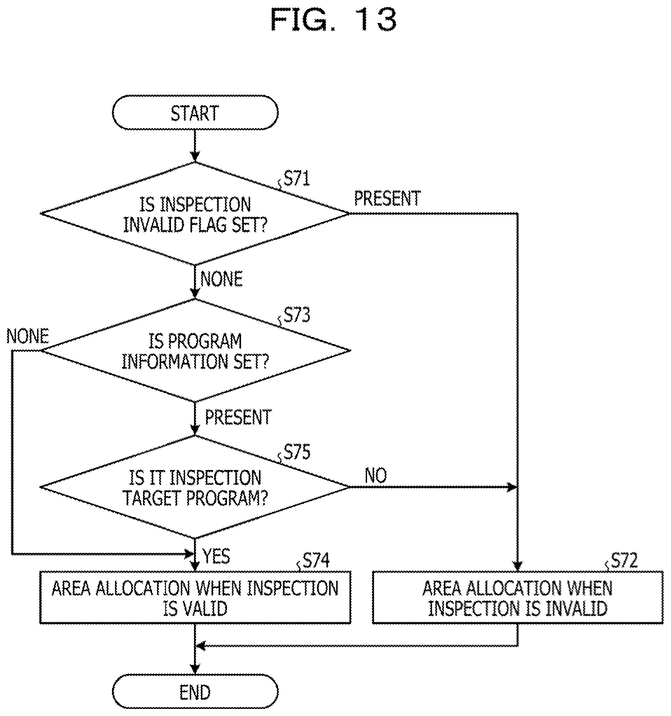

FIG. 13 is a flowchart illustrating a flow of processing by the data area acquisition unit 32. As illustrated in FIG. 13, the data area acquisition unit 32 determines whether or not the inspection invalid flag is set (step S71). When the inspection invalid flag is set, the data area acquisition unit 32 performs area allocation when the inspection is invalid (step S72).

On the other hand, when the inspection invalid flag is not set, the data area acquisition unit 32 determines whether or not the program information is set (step S73). When the program information is not set, the data area acquisition unit 32 performs area allocation when the inspection is valid (step S74). On the other hand, when the program information is set, the data area acquisition unit 32 determines whether or not the program is the inspection target program (step S75). When the program is the inspection target program, the data area acquisition unit 32 performs the area allocation when the inspection is valid (step S74). On the other hand, when the program is not the inspection target program, the data area acquisition unit 32 performs the area allocation when the inspection is invalid (step S72).

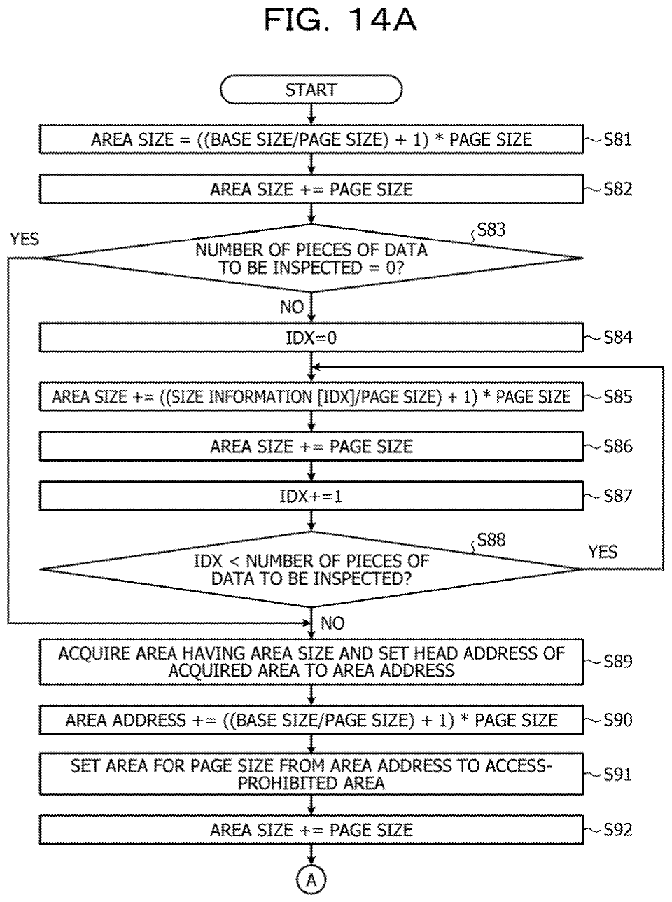

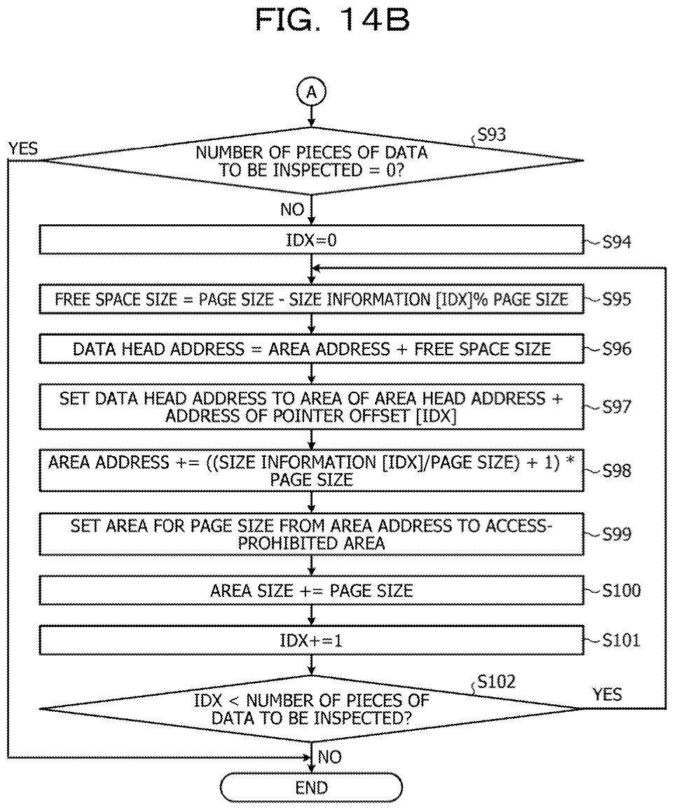

FIGS. 14A and 14B are flowcharts illustrating a flow of the area allocation processing when the inspection is valid. As illustrated in FIG. 14A, the data area acquisition unit 32 sets, as the area size, a value obtained by multiplying, by the page size, a value obtained by adding 1 to a quotient (base size/page size) obtained by dividing a base size by the page size (step S81). By this processing, the area size is set to a value which is a multiple of the page size and is obtained by adding a free space for page adjustment to the base size. The base size is a value of the base size information of the work area in the area allocation information. The data area acquisition unit 32 then adds the page size to the area size (step S82). By this processing, the area size becomes a value added with the size of the access-prohibited page.

The data area acquisition unit 32 determines whether or not the number of pieces of data to be inspected is 0 (step S83). When the number of pieces of data to be inspected is 0, the process proceeds to step S89. On the other hand, when the number of pieces of data to be inspected is not 0, the data area acquisition unit 32 initializes IDX to 0 (step S84) and adds, to the area size, a value obtained by adding 1 to a quotient obtained by dividing the size information [IDX] by the page size and multiplying the resultant by the page size (step S85). The data area acquisition unit 32 adds the page size to the area size (step S86) and adds 1 to the IDX (step S87). The data area acquisition unit 32 determines whether or not the IDX is smaller than the number of pieces of data to be inspected (step S88). When the IDX is smaller than the number of pieces of data to be inspected, the process returns to step S85.

On the other hand, when the IDX is not smaller than the number of pieces of data to be inspected, the data area acquisition unit 32 acquires an area having the area size and sets the head address of the acquired area as the area address (step S89). The data area acquisition unit 32 adds, to the area address, a value obtained by adding 1 to a quotient obtained by dividing the base size by the page size and multiplying the resultant by the page size (step S90). The data area acquisition unit 32 sets an area for the page size from the area address to an access-prohibited area (step S91) and adds the page size to the area address (step S92).

As illustrated in FIG. 148, the data area acquisition unit 32 determines whether or not the number of pieces of data to be inspected is 0 (step S93). When the number of pieces of data to be inspected is 0, the area allocation processing when the inspection is valid is ended. On the other hand, when the number of pieces of data to be inspected is not 0, the data area acquisition unit 32 initializes the IDX to 0 (step S94). The data area acquisition unit 32 sets, as a free space size, a value obtained by subtracting, from the page size, a remainder (size information [IDX]% page size) obtained by dividing the size information [IDX] by the page size (step S95). The data area acquisition unit 32 adds the free space size to the area address and sets it as a data head address (step S96).

The data area acquisition unit 32 sets the data head address to the area of the address obtained by adding the pointer offset [IDX] to the area head address (step S97). By this processing, a pointer to the data is set. The data area acquisition unit 32 adds, to the area address, a value obtained by adding 1 to a quotient obtained by dividing the size information [IDX] by the page size and multiplying the resultant by the page size (step S98). The data area acquisition unit 32 sets, to the access-prohibited area, an area for the page size from the area address (step S99) and adds the page size to the area address (step S100).

The data area acquisition unit 32 adds 1 to the IDX (step S101) and determines whether or not the IDX is smaller than the number of pieces of data to be inspected (step S102). When the IDX is smaller than the number of pieces of data to be inspected, the data area acquisition unit 32 returns to step S95. When the IDX is not smaller than the number of pieces of data to be inspected, the data area acquisition unit 32 ends the area allocation processing when the inspection is valid.

As described above, the data area acquisition unit 32 acquires the data area and performs allocation of the data and the access-prohibited page to the acquired data area and setting of the pointer to the data as the area allocation processing when the inspection is valid. Accordingly, the executable module 4 may access the data via the pointer. When the memory area overrun occurs, the OS may detect access violation.

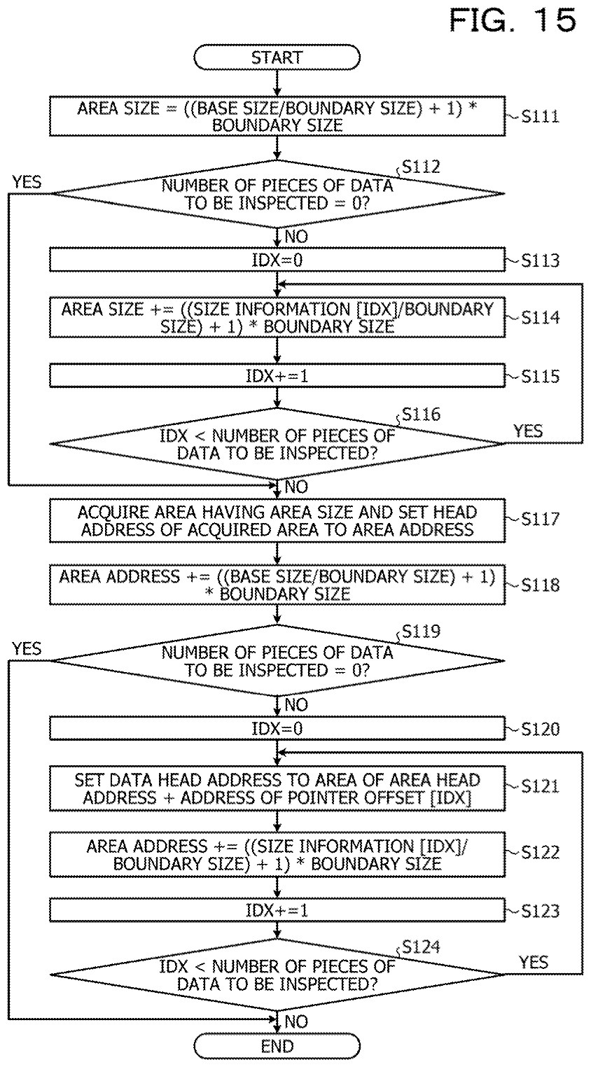

FIG. 15 is a flowchart illustrating a flow of the area allocation processing when the inspection is invalid. As illustrated in FIG. 15, the data area acquisition unit 32 sets, as the area size, a value obtained by adding 1 to a quotient obtained by dividing the base size by the boundary size and multiplying the resultant by the boundary size (step S111).

The data area acquisition unit 32 determines whether or not the number of pieces of data to be inspected is 0 (step S112). When the number of pieces of data to be inspected is 0, the process proceeds to step S117. On the other hand, when the number of pieces of data to be inspected is not 0, the data area acquisition unit 32 initializes the IDX to 0 (step S113) and adds, to the area size, a value obtained by adding 1 to a quotient obtained by dividing the size information [IDX] by the boundary size and multiplying the resultant by the boundary size (step S114). The data area acquisition unit 32 adds 1 to the IDX (step S115) and determines whether or not the IDX is smaller than the number of pieces of data to be inspected (step S116). When the IDX is smaller than the number of pieces of data to be inspected, the process returns to step S114.

On the other hand, when the IDX is not smaller than the number of pieces of data to be inspected, the data area acquisition unit 32 acquires an area having the area size and sets the head address of the acquired area as the area address (step S117). The data area acquisition unit 32 adds, to the area address, a value obtained by adding 1 to a quotient obtained by dividing the base size by the boundary size and multiplying the resultant by the boundary size (step S118).

The data area acquisition unit 32 determines whether or not the number of pieces of data to be inspected is 0 (step S119). When the number of pieces of data to be inspected is 0, the data area acquisition unit 32 ends the area allocation processing when the inspection is invalid. On the other hand, when the number of pieces of data to be inspected is not 0, the data area acquisition unit 32 initializes the IDX to 0 (step S120) and sets the data head address to the area of the address obtained by adding the pointer offset [IDX] to the area head address (step S121). The data area acquisition unit 32 adds, to the area address, a value obtained by adding 1 to a quotient obtained by dividing the size information [IDX] by the boundary size and multiplying the resultant by the boundary size (step S122).

The data area acquisition unit 32 adds 1 to the IDX (step S123) and determines whether or not the IDX is smaller than the number of pieces of data to be inspected (step S124). When the IDX is smaller than the number of pieces of data to be inspected, the data area acquisition unit 32 returns the process to step S121. When the IDX is not smaller than the number of pieces of data to be inspected, the data area acquisition unit 32 ends the area allocation processing when the inspection is invalid.

As described above, the data area acquisition unit 32 acquires the data area and performs allocation of the data to the acquired data area and setting of the pointer to the data as the area allocation processing when the inspection is invalid. Accordingly, the executable module 4 may access the data via the pointer.

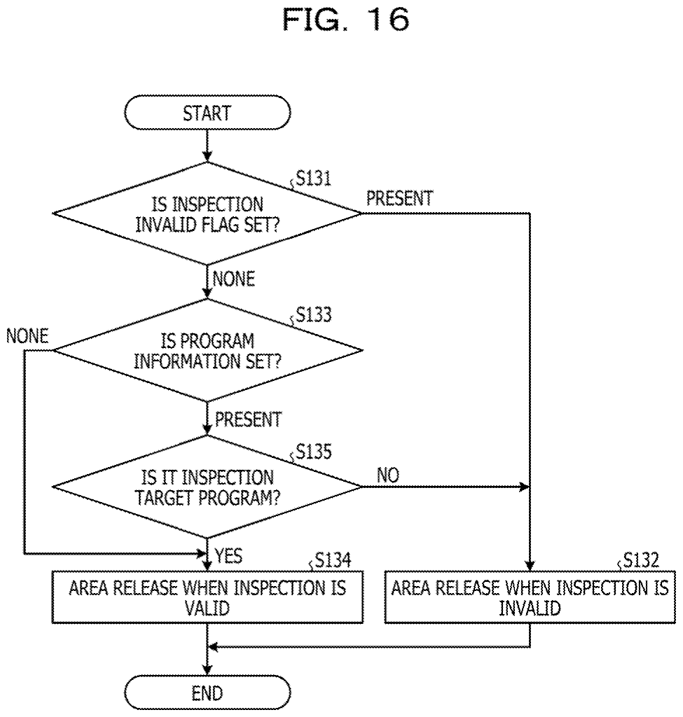

FIG. 16 is a flowchart illustrating a flow of processing by the data area release unit 34. As illustrated in FIG. 16, the data area release unit 34 determines whether or not the inspection invalid flag is set (step S131). When the inspection invalid flag is set, the data area release unit 34 performs area release when the inspection is invalid (step S132).

On the other hand, when the inspection invalid flag is not set, the data area release unit 34 determines whether or not the program information is set (step S133). When the program information is not set, the data area release unit 34 performs area release when the inspection is valid (step S134). When the program information is set, the data area release unit 34 determines whether or not the program is the inspection target program (step S135). When the program is the inspection target program, the data area release unit 34 performs the area release when the inspection is valid (step S134). On the other hand, when the program is not the inspection target program, the data area release unit 34 performs the area release when the inspection is invalid (step S132).

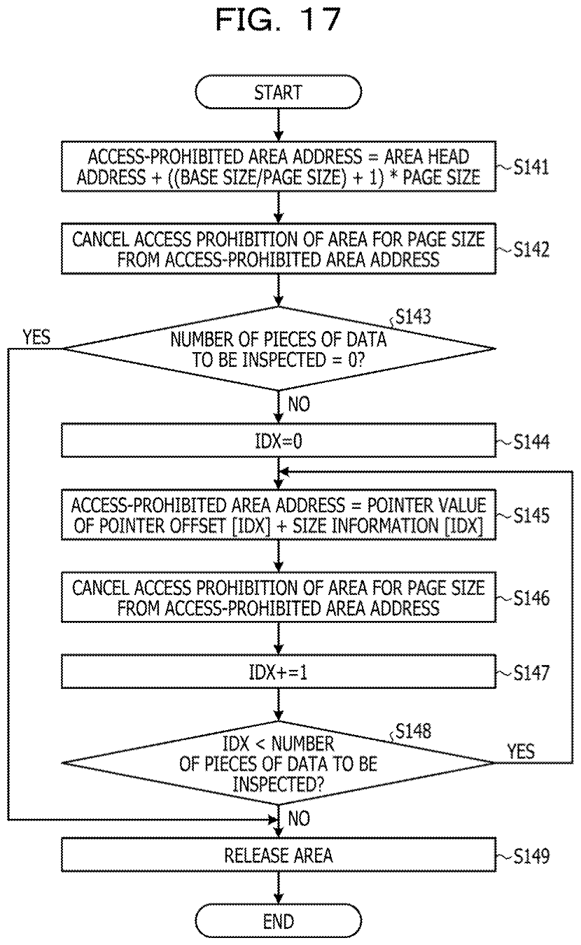

FIG. 17 is a flowchart illustrating a flow of the area release processing when the inspection is valid. As illustrated in FIG. 17, the data area release unit 34 sets, to an access-prohibited area address, a value obtained by adding, to the area head address, a value obtained by adding 1 to a quotient obtained by dividing the base size by the page size and multiplying the resultant by the page size (step S141). The data area release unit 34 cancels access prohibition of the area for the page size from the access-prohibited area address (step S142).

The data area release unit 34 determines whether or not the number of pieces of data to be inspected is 0 (step S143). When the number of pieces of data to be inspected is 0, the process proceeds to step S149. On the other hand, when the number of pieces of data to be inspected is not 0, the data area release unit 34 initializes the IDX to 0 (step S144). The data area release unit 34 sets, to the access-prohibited area address, a value obtained by adding the size information [IDX] to the value of the pointer of the pointer offset [IDX](step S145). The data area release unit 34 cancels access prohibition of the area for the page size from the access-prohibited area address (step S146) and adds 1 to the IDX (step S147).

The data area release unit 34 determines whether or not the IDX is smaller than the number of pieces of data to be inspected (step S148). When the IDX is smaller than the number of pieces of data to be inspected, the process returns to step S145. On the other hand, when the IDX is not smaller than the number of pieces of data to be inspected, the data area release unit 34 releases the area (step S149).

As described above, since the data area release unit 34 cancels the access prohibition set by the data area acquisition unit 32 and releases the area, the released area is reusable.

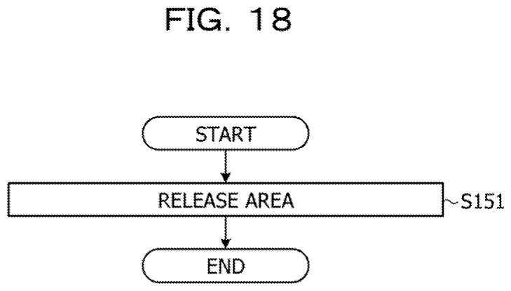

FIG. 18 is a flowchart illustrating a flow of the area release processing when the inspection is invalid. As illustrated in FIG. 18, the data area release unit 34 releases the area (step S151). As described above, the data area release unit 34 enables the released area to be reused only by releasing the area when the inspection is invalid.

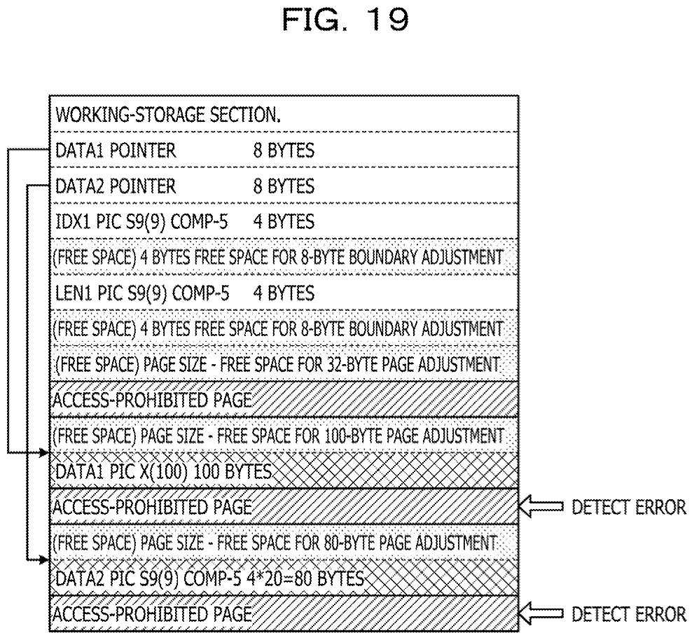

Next, effects of the inspection apparatus 1 will be described. FIG. 19 is a diagram for explaining the effects of the inspection apparatus 1. As illustrated in FIG. 19, the inspection apparatus 1 allocates “DATA1” and “DATA2”, which may cause the memory area overrun, such that “DATA1” and “DATA2” are respectively followed by access prohibited pages. Therefore, when the memory area overrun occurs in “DATA1” or “DATA2”, the OS may detect an error of access violation.

As described above, in the embodiment, the area allocator 15 generates the area allocation information for the inspection target data when the inspection target program is compiled. The data area acquisition unit 32 acquires the data area when execution of the inspection target program is started and allocates the data to the acquired data area based on the area allocation information. The data area acquisition unit 32 allocates the inspection target data such that each data is followed by the prohibited page. Accordingly, when the memory area overrun occurs, the OS detects access violation, so that the inspection apparatus 1 may detect the memory area overrun. The inspection apparatus 1 may control at runtime whether detection of the memory area overrun is made valid or invalid.

In the embodiment, the option analysis unit 31 analyzes the runtime option and specifies whether or not the inspection is valid. When the option analysis unit 31 specifies that the inspection is valid, the data area acquisition unit 32 allocates the data such that the inspection target data is followed by the prohibited page. Thus, the user may optionally specify at runtime whether detection of the memory area overrun is made valid or invalid.

In the embodiment, since the data area release unit 34 cancels setting of the prohibited page and releases the area when execution of the inspection target program is ended, it is possible to reuse the released area.

In the embodiment, the code generation unit 16 outputs the instruction to call the runtime library 5 that acquires the area for which the inspection validity and the inspection invalidity are switchable. Therefore, the data area acquisition unit 32 may acquire the data area and allocate the data to the acquired data area based on the area allocation information.

Although the inspection apparatus 1 has been described in the embodiment, an inspection program having similar functions may be obtained by implementing the configuration of the inspection apparatus 1 by software. A computer that executes the inspection program will now be described.

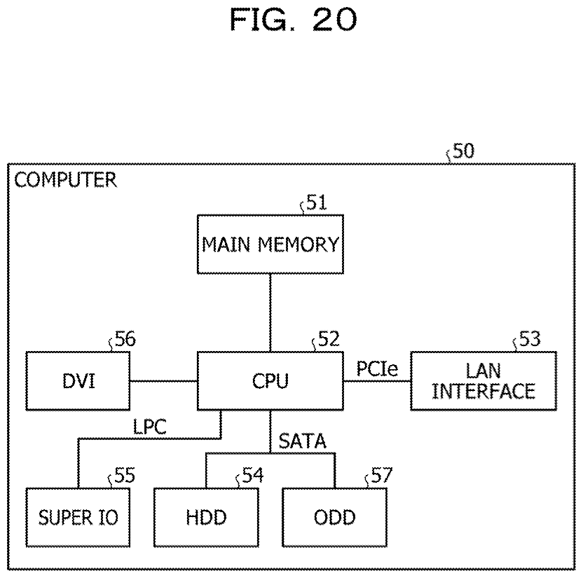

FIG. 20 is a diagram illustrating the hardware configuration of the computer that executes the inspection program according to the embodiment. As illustrated in FIG. 20, a computer 50 includes a main memory 51, a central processing unit (CPU) 52, a local area network (LAN) interface 53, and a hard disk drive (HDD) 54. The computer 50 further includes a super input output (IO) 55, a Digital Visual Interface (DVI) 56, and an optical disk drive (ODD) 57.

The main memory 51 is a memory that stores therein a program, a halfway result of program execution, and the like. The CPU 52 is a central processing unit that reads out the program from the main memory 51 and executes the program. The CPU 52 includes a chipset having a memory controller.

The LAN interface 53 is an interface that couples the computer 50 to another computer through the LAN. The HDD 54 is a disk device that stores therein a program and data, and the super IO 55 is an interface that couples input devices such as a mouse or a keyboard. The DVI 56 is an interface that couples a liquid crystal display device, and the ODD 57 is a device that performs reading from and writing into a digital versatile disc (DVD).

The LAN interface 53 is coupled to the CPU 52 by Peripheral Component Interconnect Express (PCIe). The HDD 54 and the ODD 57 are coupled to the CPU 52 by Serial Advanced Technology Attachment (SATA). The super IO 55 is coupled to the CPU 52 by Low Pin Count (LPC).

The inspection program that is executed by the computer 50 is stored in the DVD as an example of a recording medium which is readable by the computer 50, is read out from the DVD by the ODD 57, and is installed in the computer 50. Alternatively, the inspection program is stored in a database or the like of another computer system coupled through the LAN interface 53, is read out from the database or the like, and is installed in the computer 50. The installed inspection program is stored in the HDD 54, is read out to the main memory 51, and is executed by the CPU 52.

In the embodiment, the access violation is detected when the index value of the array is larger than the size of the array. Alternatively, the inspection apparatus 1 may detect the access violation when the index value of the array is a negative value. The inspection apparatus 1 may detect access violation when the index value of the array is the negative value by allocating the array to the head of the page and prohibiting access to a previous page of the page to which the array is allocated.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An inspection system comprising:
a memory; and
a processor coupled to the memory and configured to:
generate, upon compilation, first information related to allocation of an area of access target data and correlate the first information with an inspection target program based on whether or not access to the access target data when the inspection target program is executed is access to inspection target data with a possibility of violation access to an area other than a memory area of the data; and
perform allocation to prohibit the violation access for the inspection target data based on the first information generated by the generation unit in the allocation of the area of the access target data when execution of the inspection target program is started.

2. An inspection method in which a computer is caused to execute processing of:
generating, upon compilation, first information related to allocation of an area of access target data and correlating the first information with an inspection target program based on whether or not access to the access target data when the inspection target program is executed is access to inspection target data with a possibility of violation access to an area other than a memory area of the data; and
performing allocation to prohibit the violation access for the inspection target data based on the first information in the allocation of the area of the access target data when execution of the inspection target program is started.

3. A non-transitory computer-readable recording medium having stored therein a program causing a computer to execute processing of:
generating, upon compilation, first information related to allocation to prohibit violation access to an area of access target data and correlating the first information with an inspection target program based on whether or not access to the access target data when the inspection target program is executed is access to inspection target data with a possibility of violation access to an area other than a memory area of the data.

4. The non-transitory computer-readable recording medium according to claim 3,
wherein the first information includes a size of an area as a combination of an area of a pointer which is used for accessing the inspection target data and an area of data other than the inspection target data, the number of pieces of inspection target data, and a size of each inspection target data.

5. The non-transitory computer-readable recording medium according to claim 3,
wherein the computer is further caused to execute processing of generating, upon compilation of the inspection target program, a code for executing, by a runtime library based on the first information, processing of performing the allocation to prohibit the violation access when execution of the inspection target program is started, and embedding the code in an object code.

6. The non-transitory computer-readable recording medium according to claim 3,
wherein a processing of performing the allocation to prohibit the violation access includes acquiring the area of the access target data, allocating the inspection target data to be adjacent to a boundary of pages, and setting a page immediately before or after the inspection target data at the boundary to an access prohibited page.

7. The non-transitory computer-readable recording medium according to claim 3,
wherein the computer is further caused to execute processing of determining whether or not inspection validity is designated in accordance with an option when the inspection target program is executed; and
when the inspection validity is designated, the computer is caused to execute the processing of performing the allocation to prohibit the violation access.

8. The non-transitory computer-readable recording medium according to claim 6,
wherein the computer is further caused to execute processing of canceling the access prohibition and releasing the acquired area when the execution of the inspection target program is ended.
